(19) United States
(12) Patent Application Publication
(10) Pub. No.: US 2012/0183371 A1
(43) Pub. Date: Jul. 19, 2012

(54) Engineered Lumber Panel Fastener

(76) Inventors: Thomas P. Druschel, Holyoke, MA (US); Tad A. Weiss, Westhampton, MA (US); Richard L. Belinda, Westfield, MA (US); Michael W. Maziarz, Wilbraham, MA (US); Joseph A. Pieciak, JR., West Springfield, MA (US); Walter J. Danek, Ludlow, MA (US); Kevin G. Walters, Feeding Hills, MA (US)

(21) Appl. No.: 13/499,411

(22) PCT Filed: Oct. 5, 2010
(86) PCT No.: PCT/US10/51412

§ 371 Date: Mar. 30, 2012

Related U.S. Application Data
(60) Provisional application No. 61/278,295, filed on Oct. 5, 2009.

(51) Int. Cl. F16B 25/10; F16B 35/04

(52) U.S. Cl. 411/387.1; 411/411; 411/412

(57) ABSTRACT

A fastener adapted for anchoring engineered lumber panels has a threaded portion with a double included securement thread having an included angle between 15° and 25°. The ratio of the major thread diameter to the minor diameter exceeds 2.0 to provide a large thread surface to resist pull out. The fastener also includes a drill tip having an effective diameter substantially equal to the minor diameter of the thread. The fastener is configured to resist cocking upon being driven into the engineered lumber panel and to resist marring of the panel fascia.

### CROSS-REFERENCE TO RELATED APPLICATION

This application claims the priority of U.S. Provisional Application No. 61/278,295 filed on Oct. 5, 2009, the disclosure of which is incorporated herein in its entirety.

### BACKGROUND

This disclosure relates generally to fasteners employed for securing wood based construction materials. More particularly, this disclosure relates to fasteners employed for securing oriented strand board (OSB), plywood, particle board, and chipboard (collectively termed herein “engineered lumber panels”) to structural support members.

In applications for which the present fastener is particularly adapted, sheets of OSB, plywood and other engineered lumber panels are employed for roofing applications, especially in commercial roofing applications.

The use of engineered lumber panels requires fasteners which can provide a consistent fastening integrity for a significant period of time. Commonly the engineered lumber panels have wide variations in composition and structural characteristics which at least in part are a function of the wood species, manufacturing processes and other variables. There can actually be significant variations in a given pallet of materials. In addition, the cross-section composite profile of the engineered lumber panel material is in many instances far from uniform.

The usage of OSB and plywood in roofing applications also means that the materials are likely subject to significant environmental lifting forces over a long period of time, and reliable integrity of the securement is a practical requirement. Pullout of the fastener is a particularly significant problem for relatively thin engineered lumber panels.

### SUMMARY

Briefly stated, a fastener for engineered lumber material comprises a head which is adapted to receive a torque such as a socket or a Phillips recess. A shank extends from the head and has an unthreaded portion adjacent the thread and an intermediate threaded portion and terminates in a drill tip. The threaded portion comprises a securement thread having an included angle in the range of 15°-25°. The ratio of the major diameter of the thread to the minor diameter of the thread exceeds 2.0. The thread pitch is in the range of 6-10 threads per inch. The thread is a double angle thread. A tapered transition thread extends from the securement thread to the drill tip.

In one preferred embodiment for a three inch fastener, the securement thread extends approximately 1.875 inches, and has an included thread angle of 20° and a pitch of 8 threads per inch. In one embodiment, the shoulder has opposed surfaces which form a shoulder included angle of 82°. The shoulder is adjacent the surface defined by the minor diameter. The drill tip has an effective diameter which is substantially commensurate with the minor diameter of the threaded portion. The drill tip in some embodiments terminates in a half-point configuration.

For an engineered lumber panel having a pre-established thickness T and an associated fastener for anchoring the panel to a roof substrate, the unthreaded portion adjacent the head longitudinally extends substantially the distance T. In addition, the drill tip has a length which is substantially equal to or greater than T.

### BRIEF DESCRIPTION OF THE DRAWINGS

FIG. 1 is an enlarged elevational view of an engineered lumber panel fastener;

FIG. 2 is an elevational view, partly in diagrammatic form, of the fastener of FIG. 1;

FIG. 3 is a central sectional view, partly in diagrammatic form, of the fastener of FIG. 2 taken along the lines of A-A thereof;

FIG. 4 is a top plan view of the fastener of FIG. 2;

FIG. 5 is an enlarged sectional view, partly in diagrammatic form, of the B portion of the fastener of FIG. 3;

FIG. 6 is a side view, partly in diagrammatic form, of a second embodiment of an engineered lumber panel fastener;

FIG. 7 is an end view of the head of the fastener of FIG. 6;

FIG. 8 is a diagram of a portion of a thread form for the fastener of FIG. 6;

FIG. 9 is an elevated representational view of an engineered lumber panel fastener as it is being driven into an engineered lumber panel;

FIG. 10 is an enlarged elevational view of a third embodiment of an engineered lumber panel fastener;

FIG. 11 is an enlarged view of a tip portion of the fastener of FIGS. 10; and

FIG. 12 is an enlarged view, partly in diagrammatic form, of the tip portion of FIG. 11, viewed from the left side thereof.

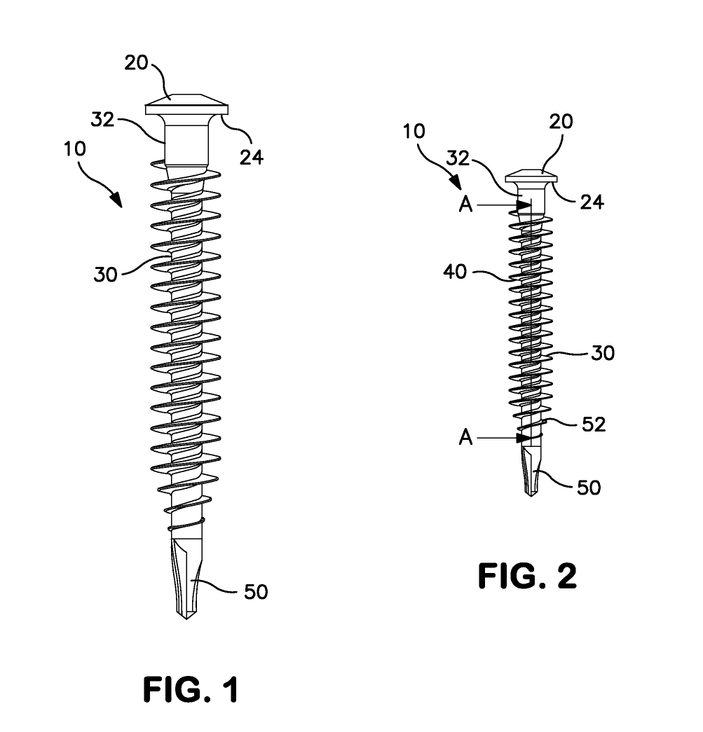

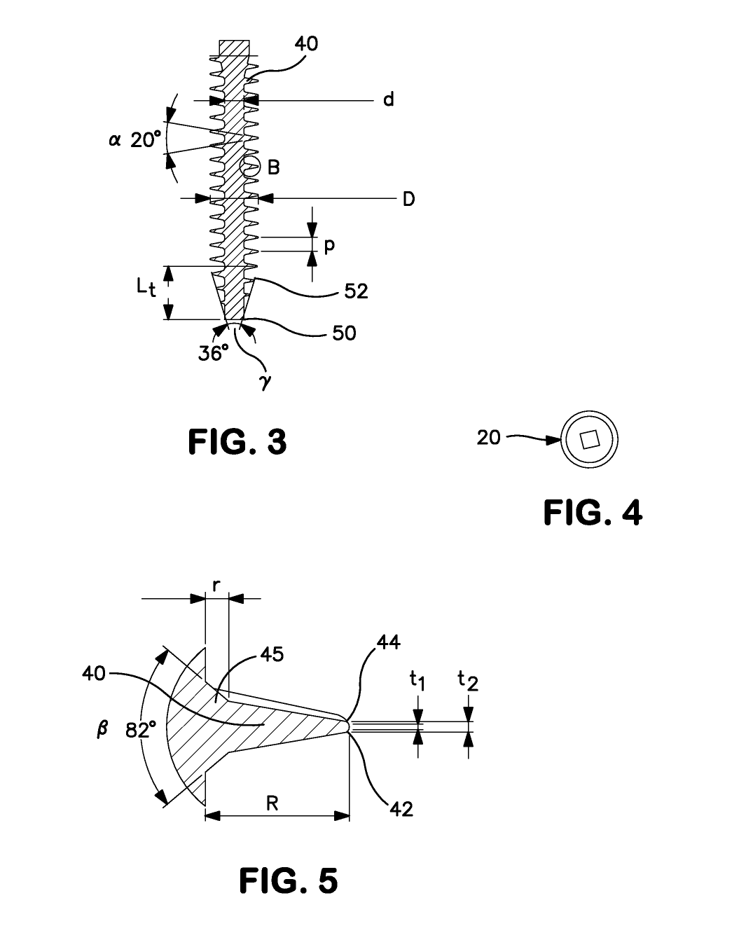

### DETAILED DESCRIPTION

With reference to the drawings wherein like numerals represent like parts throughout the figures, a representative fastener generally designated by the numeral 10 is especially adapted for securing OSB, plywood and other engineered lumber panels for roofing applications. Fastener 10 functions to provide a panel fastener of high securement integrity and a high degree of pull-out resistance. The fastener 10 is self-drilling and is configured for efficient driving.

The fastener 10 has a head 20 and a shank 30 which is partially threaded and terminates in a drill tip 50. The fastener 10 in one representative embodiment has a length of 3.00 inches which may, for example, be suitably employed with an OSB board having a thickness 7/16 inches. The fastener 10 has a head 20 with a No. 3 square drive socket 22 and a head diameter of approximately 0.500 inches (for the fastener of 3.00 inches). The fastener is preferably formed from a carbon steel blank (not illustrated) with a diameter of 0.252 inches. Other materials are also possible.

One preferred illustrated representative fastener 10 is described below. The fastener thread can be characterized as being relatively thin—especially at the peripheral portions—and extending radially a relatively large distance so as to form a relatively large thread surface area. The shank 30 has a double angle securement thread 40 which has an interior included angle α of approximately 20° with a slightly rounded peripheral edge 42. With reference to FIG. 5, the peripheral thread portion 44 which is adjacent to the peripheral edge has a thickness t₁, t₂ which ranges from 0.005 to 0.009 inches. The thread 40 includes a transition shoulder 45 of enlarged mass which projects a distance of 0.02 inches radially from the shaft with the opposed upper and lower transition shoulders 46, 48 being at an angle β of approximately 82 degrees. The radial dimension R of the thread 40 is approximately 0.125 inches. The thread 40 has a minor diameter d of 0.170 inches and a major diameter D of 0.420 inches. The pitch is 8 threads per inch; thus, the distance on center between the threads P is 0.125 inches.

For the representative fastener 10, the thread 40 longitudinally extends approximately 1.875 inches (for a 3.00 inch fastener), and the unthreaded portion 32 between the thread 40 and the underside 24 of the head extends approximately 0.25 ins.

In the illustrated representative embodiment of fastener 10, the drill tip 50 has a drill tip angle γ of approximately 36 degrees. There is a gradual tapered transition thread 52 which extends a transition distance Lₜ of approximately 0.461 inches for transitioning from the drill point to the thread. The drill tip 50 is configured to provide a clean entry bore for the thread 40 with a minimal disruption of the panel fascia.

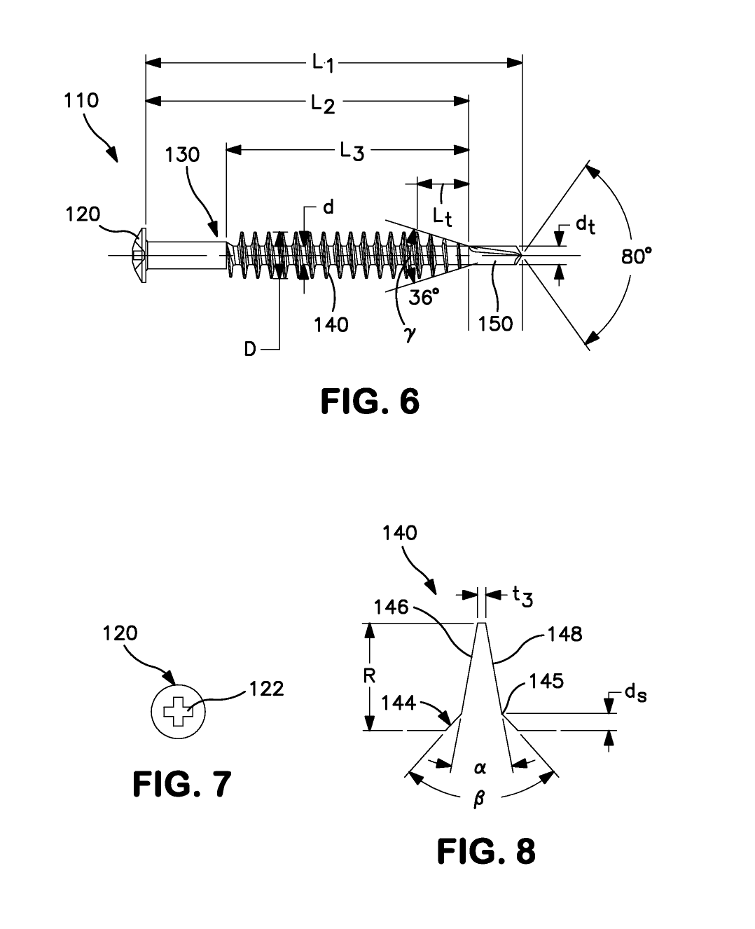

With reference to FIGS. 6-8, another representative fastener 110 has a geometry which principally differs from that of fastener 10 in terms of the head configuration and is illustrated for purposes of describing additional features and relationships. The fastener 110 has a head 120 with a #3 Phillips recess 122. The diameter of head 120 is preferably approximately 0.425-0.450 inches.

The fastener 110 is formed in various lengths in accordance with the intended application which is at least partially a function of the panel thickness, the roofing sub-structure and environmental considerations. The drill tip length is typically approximately the thickness of the engineered lumber panel which, for the illustrated embodiment is approximately 0.500 inches. Table 1 set forth below indicates, in inches, the length L₁, the usable length L₂ and the thread length L₃ for variously dimensioned fasteners 110.

TABLE 1

| | | | | | | |
|---|---|---|---|---|---|---|
| L1 | 2.50 | 3.50 | 4.50 | 5.50 | 6.50 | 7.50 |
| L2 | 2.00 | 3.00 | 4.00 | 5.00 | 6.00 | 7.00 |
| L3 | 1.50 | 1.50 | 1.50 | 2.50 | 2.50 | 2.50 |

The shank 130 has a double angle securement thread 140 with a pitch of 8 threads per inch and an interior included angle α of approximately 20°. The thread portion 144 which is adjacent to the rounded peripheral edge also has a thickness t₃ which ranges from 0.005 to 0.009 inches. The thread 140 also includes a transition shoulder 145 to provide a reinforcement structure since the thread is generally relatively thin and with a relatively large radial extent. The transition shoulder 145 projects a distance dₛ of 0.02 inches radially from the central shaft portion (surface defining the minor diameter) with the opposed upper and lower transition shoulders 146 and 148 having an angle β of approximately 82°. The radial dimension R of the thread 140 is approximately 0.125 inches. The thread 140 has a minor diameter d of 0.170 inches and a major diameter D of 0.420 inches.

The drill tip 150 has a drill tip angle γ of approximately 36°. There is a gradual tapered transition thread 152 which also extends a transition distance Lₜ of approximately 0.461 inches for transitioning from the drill point to the thread 140. The drill tip 150 is configured to provide a clean entry bore into the lumber paneled fastener for minimal disruption of the panel fascia.

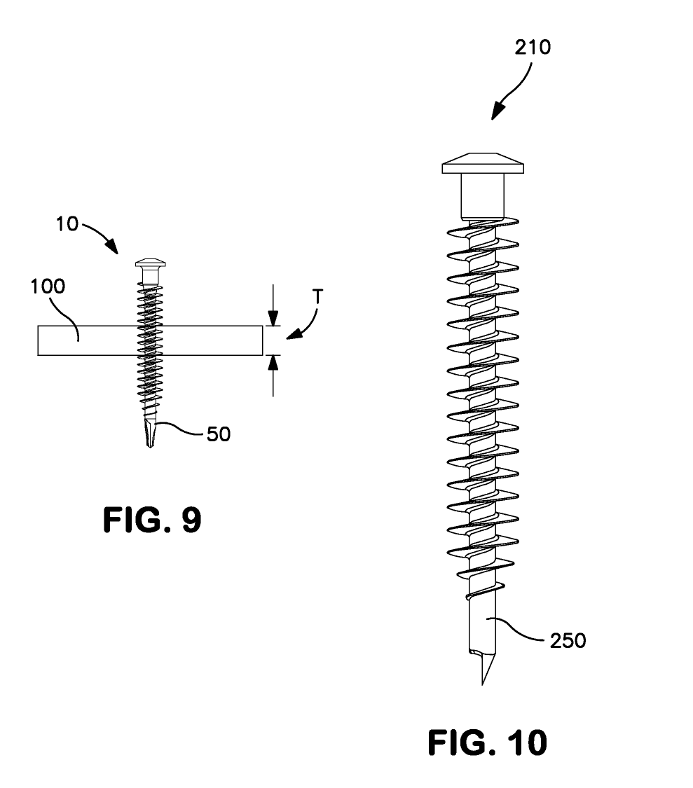

As illustrated in FIG. 9, the preferred diametral dimensional relationship between the drill tip 150 and the thickness T of the engineered lumber panel is approximately the same. The drill tip, in some embodiments, has a length greater than the panel thickness T. It should be noted that the diameter of the drill tip dₜ is approximately equal to the minor diameter d of the thread.

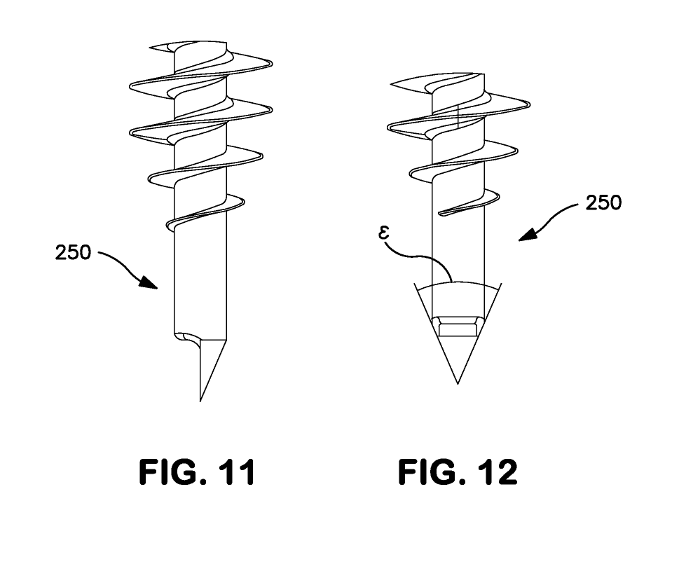

With reference to FIGS. 10-12, fastener 210 is substantially identical to fastener 10 except for drill tip 250. The drill tip 250 terminates in a half-point configuration. The point angle ε is preferably 30° to 60°, and in one embodiment, is 45°. For certain applications, the half-point configuration facilitates the drill tip entry and initial tapping/drilling process.

The fasteners may be cold formed from 1022 carbon steel. The fastener workpieces is then heat treated and painted. Alternatively, the fasteners may also be formed from aluminum. The aluminum workpieces may then be heat treated and possibly painted. The fasteners may also be formed from zinc alloys, composites such as nylon 66 glass filled materials, and other materials. The fasteners can also be manufactured by a molding process.

A suitable engineered lumber panel fastener 10, 110, 210 has a number of preferred characteristics. The ratio of the major diameter to the minor diameter (D/d) is preferably greater than 2.0. The ratio D/d is also preferably less than 3.0 to ensure proper thread formation for certain cold forming processes. The securement thread angle α is preferably in the range 15° to 25°. The ratio of the included shoulder angle β to the thread angle α (Angle β/Angle α) is preferably greater than 4.0. The pitch is preferably between 6 and 10 threads per inch.

It will be appreciated that the foregoing fasteners 10, 110, 210, upon being driven into the OSB, plywood or other laminated lumber panel, essentially slice through the panel and minimally disrupts and displaces the composite material. A clean bore initially produced by the drill tip is slightly greater in diameter than the minor diameter of the thread. The bore forming is then followed by a shallow angled deep thread that cuts through the material. The exaggerated radial thread penetration provides high pull-out characteristics of the fastener for a wide range of engineered lumber panels. The fastener 10, 110, 210 is balanced as it is driven due to the tight pitch of the threads so that it does not tend to cock from normal even when installed in ½ inch thick panels.

A fastener 110 constructed as previously described was tested in connection with OSB and plywood produced by Peace Valley OSB Diyallup, Washington. The OSB board and the plywood were rated at 7/16 inches. Fasteners such as fastener 110 as described were driven into the OSB board and the plywood. Afterward, a pull test for each of the driven fasteners was undertaken. The pull-out values averaged 468 lbs. The average pull-out value for the 7/16^{th} inch plywood was 365 lbs.

In another test, a 6 inch fastener, such as described by fastener 110, was subjected to a pull-out testing in 15/32 inch OSB sheathing of Louisiana Pacific-Mill No. 459. The pull-out testing was compared to 6 inch #14 and 6 inch #15 heavy duty fasteners marketed by OMG, Inc. of Agawam, Mass. The average pull-out force was determined to be 400 pounds as compared to the average pull-out force of 262 pounds for the #14 fastener and 228 pounds for the #15 fastener.

What is claimed:

1. A fastener for engineered lumber material comprising:
a head adapted to receive a torque; and
a shank extending from said head and having an unthreaded portion adjacent said head and an intermediate threaded portion and terminating in a drill tip, said threaded portion comprising a securement thread having an included angle in the range of 15° to 25°, a major diameter and a minor diameter wherein the ratio of the major diameter to the minor diameter exceeds 2.0, and a pitch in the range of 6-10 threads per inch.

2. The fastener of claim 1 wherein said thread is a double angle thread.

3. The fastener of claim 2 further comprising a tapered transition thread extending from said securement thread to said drill tip.

4. The fastener of claim 1 wherein said included angle is 20°.

5. The fastener of claim 1 wherein the pitch is 8 threads per inch.

6. The fastener of claim 1 wherein the drill tip has an effective diameter which is substantially commensurate with the minor diameter of the threaded portion.

7. The fastener of claim 2 wherein the thread defines a shoulder adjacent a surface defined by said minor diameter.

8. The fastener of claim 7 wherein the thread defines an included shoulder angle greater than the thread included angle.

9. The fastener of claim 8 wherein the ratio of the included shoulder angle and to the thread included angle is greater than 4.0.

10. The fastener of claim 1 wherein the drill tip terminates in a half-point configuration.

11. The fastener of claim 1 wherein the thread has a radially inward shoulder of enlarged mass compared to peripheral portions of the thread.

12. The fastener of claim 1 wherein the ratio of the maximum diameter to the minimum diameter is less than 3.0.

13. In combination, an engineered lumber material having a pre-established thickness T and a fastener anchoring said panel, said fastener comprising:
a head adapted to receive a torque; and
a shank extending from said head and having an unthreaded portion adjacent said head longitudinally extending substantially the distance T, an intermediate threaded portion threaded to said panel and terminating in a drill tip having a length substantially equal to or greater than T, said threaded portion comprising a securement thread having an included angle in the range of 15° to 25°, a major diameter and a minor diameter wherein the ratio of the major diameter to the minor diameter exceeds 2.0, and a pitch in the range of 6-10 threads per inch.

14. The fastener of claim 13 wherein said thread is a double angle thread.

15. The fastener of claim 14 further comprising a tapered transition thread extending from said drill tip to said securement thread.

16. The fastener of claim 13 wherein said included angle is 20°.

17. The fastener of claim 13 wherein the pitch is 8 threads per inch.

18. The fastener of claim 13 wherein the drill tip has an effective diameter which is substantially commensurate with the minor diameter of the threaded portion.

19. The fastener of claim 13 wherein the thread has a radially inward shoulder of enlarged mass compared to peripheral portions of the thread.

20. The fastener of claim 13 wherein the drill tip terminates in a half-point configuration.
